(19) United States
(12) Patent Application Publication
(10) Pub. No.: US 2020/0198570 A1
(43) Pub. Date: Jun. 25, 2020

(54) AIRBAG ASSEMBLY HAVING AN AUGMENTED INFLATABLE AIRBAG CUSHION

(71) Applicant: GM Global Technology Operations LLC, Detroit, MI (US)

(72) Inventors: Sadanand N. Raikar, Bengaluru (IN); Jeffrey J. Schultz, Grand Blanc, MI (US); Lisa M. Furton, Beverly Hills, MI (US); Srinivas Surampudi, Bangalore (IN); Mukesh Amin, Canton, MI (US)

(21) Appl. No.: 16/225,288

(22) Filed: Dec. 19, 2018

(51) Int. Cl. B60R 21/2338

(52) U.S. Cl. CPC B60R 21/2338; B60R 2021/0004

(57) ABSTRACT

An airbag system having an airbag control module configured to detect a direction of impact of a vehicle, an airbag assembly having an airbag cushion with an internal tether, and a tether adjustment mechanism. The tether adjustment mechanism is in communication with the airbag control module and engagement with the tether. The airbag control module is configured to send a signal to the tether adjustment mechanism to adjust the tether by ratcheting a portion of the middle segment of the tether when the airbag cushion deploys such that one of a first tether length and a second tether length is extended and the other of the first tether length and the second tether length is contracted to provide a larger volumetric capacity of the airbag cushion in the direction of impact.

### INTRODUCTION

The present disclosure relates to an airbag restraint system for a vehicle, and more particularly to an airbag assembly having an adjustable tether that controls the expansion profile characteristics of an inflatable airbag cushion deployed based upon a direction of impact.

A typical airbag assembly includes an inflatable airbag cushion for protecting the occupants of a vehicle. A deployment of the inflatable airbag cushion is triggered when a vehicle-specific crash impact severity condition is satisfied. In an on-road motor vehicle, airbag assemblies are typically located within the hub of the steering wheel, in hidden compartments within an instrument panel, in hidden pockets within a seat or door trim panels, and/or in structural components of the vehicle such as pillars, roof or roof line for the protection of the occupants during a severe front and/or side impact event. Airbag assemblies in the pillars or roof line of the motor vehicle may also deploy to restrain and protect the occupants of the motor vehicle during a roll-over event.

Airbag assemblies typically include an inflatable airbag cushion and a gas emitting inflator. A vehicle sensing system will discriminate impact severity and command deployment based on pre-determined vehicle-specific inputs, such as a certain rate of vehicle deceleration. With the command deployment, the inflator discharges a fixed amount of inflator gas into a folded inflatable airbag cushion, thereby forcing the inflatable airbag cushion into an inflated deployed position. The inflator gas occupies the available volume within the airbag cushion thereby forcing the airbag cushion to expand outwardly to the extent permitted by its deployed geometry.

Airbag cushions typically have a fixed deployed geometry, which is optimized to protect the occupants depending on the location of the airbag assembly within the vehicle. The fixed deployed geometries of the inflatable airbag cushions are designed for specific types of vehicle impacts. For example, the airbag assemblies located in the hub of the steering wheel and in the hidden compartments of the instrument panel have airbag cushions with fixed deployed geometries that are optimized to protect the front seat occupants in the event of a severe frontal impact on the vehicle. For another example, the airbag assemblies located in the seats and door panels have airbag cushions with fixed deployed geometries that are optimized to protect occupants in the event of a severe side impact on the vehicle.

Thus, while airbag assemblies having inflatable airbag cushions with fixed deployed geometries achieve their intended purpose, there is a need for an augmented inflatable airbag cushion where the deployed geometry is reconfigurable to provide an additional degree of protection for the occupants in the event of an impact that is not a direct front impact or a direct side impact.

### SUMMARY

According to several aspects, an augmented air bag assembly is disclosed. The augmented air bag assembly includes an inflator for generating a gas; an airbag cushion deployable upon generation of the gas by the inflator; a tether having a first end connected to a first portion of the airbag cushion, a second end connected to a second portion of the airbag cushion, and a middle segment extending between the first end and the second end; a tether adjustment mechanism engaged to a portion of the middle segment of the tether, thereby defining a first tether length between the tether adjustment mechanism and the first end, and a second tether length between the tether adjustment mechanism and the second end. The tether adjustment mechanism is configured to ratchet the portion of the middle segment of the tether when the airbag cushion deploys such that one of the first tether length and the second tether length is extended, and the other of the first tether length and the second tether length is contracted.

In an additional aspect of the present disclosure, the middle segment includes a fixed tether length.

In another aspect of the present disclosure, the one of first tether length and second tether length is extended to a predetermined length, and the other of the first tether length and the second tether length is contracted the same predetermined length.

In another aspect of the present disclosure, the first portion of the airbag cushion is a right lateral portion of the airbag cushion when the airbag cushion is deployed and the second portion of the airbag cushion is a left side portion of the airbag cushion when the airbag cushion is deployed.

In another aspect of the present disclosure, the airbag cushion includes an exterior surface defining a lateral external face, and an interior surface defining a lateral internal face opposite of the lateral external face and an interior volume. The tether is disposed within the interior volume of the airbag cushion. The first end and second end of the tether is connected to the right lateral portion and to the left lateral portion of the lateral internal face.

In another aspect of the present disclosure, the tether adjustment mechanism comprises a housing; a cam member pivotally disposed within the housing, the cam member including a lever having a first surface and an opposing second surface; a first plunger selectively engageable with the first surface to induce a rotation of the cam member in a first pivotal direction, thereby causing the first tether length to extend in the first direction; and a second plunger selectively engageable with the second surface to induce a rotation of the cam member in a second pivotal direction, thereby causing the second tether length to extend in the first direction.

In another aspect of the present disclosure, the cam member further includes a plurality of pawl teeth engaging the portion of the middle segment of the tether.

In another aspect of the present disclosure, the tether adjustment mechanism includes a tether locking tab configured to compress the portion of the middle segment against the housing such that the tether is immobilized.

In another aspect of the present disclosure, the first and second plungers are slidable through a first and second openings, respectively, defined in the housing.

In another aspect of the present disclosure, the tether includes a continuous sheet of flexible foldable fabric material that is resistant to substantial elongation upon the application of tensile forces during deployment of the airbag cushion.

According to several aspects, airbag system for a vehicle is disclosed. The airbag system for a vehicle includes an airbag control module configured to detect a direction of impact of a vehicle and to deploy an airbag assembly upon certain conditions of impact. The airbag assembly includes an airbag cushion having an exterior surface defining a lateral external face, and interior surface defining a lateral internal face opposite of the lateral external face and interior volume. A tether is disposed within the interior volume of the airbag cushion. The tether includes a first end and a second end, wherein the first end and second end of the tether is connected to a right portion and to a left portion of the lateral internal face, respectively. The airbag assembly further includes a tether adjustment mechanism in communication with the airbag control module and engagement with the tether. The airbag control module is configured to send a signal to the tether adjustment mechanism to adjust the tether such that the deployed profile of the airbag cushion is expanded in the general direction of impact.

In an additional aspect of the present disclosure, the tether further includes a middle segment extending between the first end and the second end. The tether adjustment mechanism is engaged to a portion of the middle segment of the tether, thereby defining a first tether length between the tether adjustment mechanism and the first end, and a second tether length between the tether adjustment mechanism and the second end.

In another aspect of the present disclosure, the tether adjustment mechanism is configured to ratchet the portion of the middle segment of the tether when the airbag cushion deploys such that one of first tether length and second tether length is extended and the other of the first tether length and the second tether length is contracted to provide a larger volumetric capacity of the airbag cushion in the direction of impact.

In another aspect of the present disclosure, the tether adjustment mechanism includes a cam member including a lever having a first surface and an opposing second surface; a first plunger selectively engageable with the first surface to induce a rotation of the cam member in a first pivotal direction, thereby causing the first tether length to extend in the first direction; and a second plunger selectively engageable with the second surface to induce a rotation of the cam member in a second pivotal direction, thereby causing the second tether length to extend in the first direction.

In another aspect of the present disclosure, the cam member further includes a plurality of pawl teeth engaging the portion of the middle segment of the tether.

According to several aspects, an augmented airbag assembly having a reconfigurable deploy geometry is disclosed. The augmented airbag assembly includes a tether having a first end, an opposite second end, and a middle segment extending between the first end and the second end;—a tether adjustment mechanism engaged to a portion of the middle segment of the tether, thereby defining a first tether length between the tether adjustment mechanism and the first end, and a second tether length between the tether adjustment mechanism and the second end.

In an additional aspect of the present disclosure, the augmented airbag assembly further includes an airbag cushion having an exterior surface defining a lateral external face, and interior surface defining a lateral internal face opposite of the lateral external face and interior volume. The tether is disposed within the interior volume of the airbag cushion, wherein the first end and second end of the tether is connected to a right portion and to a left portion of the lateral internal face, respectively.

In another aspect of the present disclosure, the augmented airbag assembly further includes an airbag control module configured to detect a direction of impact of a vehicle and to deploy an airbag assembly upon predetermined conditions of impact, wherein the airbag control module is in communication with the tether adjustment mechanism.

In another aspect of the present disclosure, the airbag control module sends a signal to the tether adjustment mechanism to ratchet the portion of the middle segment of the tether when the airbag cushion deploys such that one of first tether length and second tether length is extended, and the other of the first tether length and the second tether length is contracted.

In another aspect of the present disclosure, one of first tether length and second tether length is extended to a predetermined length, and the other of the first tether length and the second tether length is contracted to the same predetermined length.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a diagrammatic cut-away top view of a motor vehicle having an inflatable airbag cushion deploying in response to a left-offset front impact, according to an exemplary embodiment;

FIG. 1B is a diagrammatic cut-away top view of a motor vehicle having an inflatable airbag cushion deploying in response to a center front impact, according to an exemplary embodiment;

FIG. 1C is a diagrammatic cut-away top view of a motor vehicle having an inflatable airbag cushion deploying in response to a right-offset front impact, according to an exemplary embodiment;

FIG. 2 is a diagrammatic top view of an airbag cushion deployed in response to a center front impact compared to the augmented airbag cushion deployed in response to a right-offset front impact;

FIG. 3 is a schematic illustration of an airbag assembly having a reconfigurable length internal tether, according to an exemplary embodiment; and

FIG. 4 is a mechanism for proportioning the length of the internal tether, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

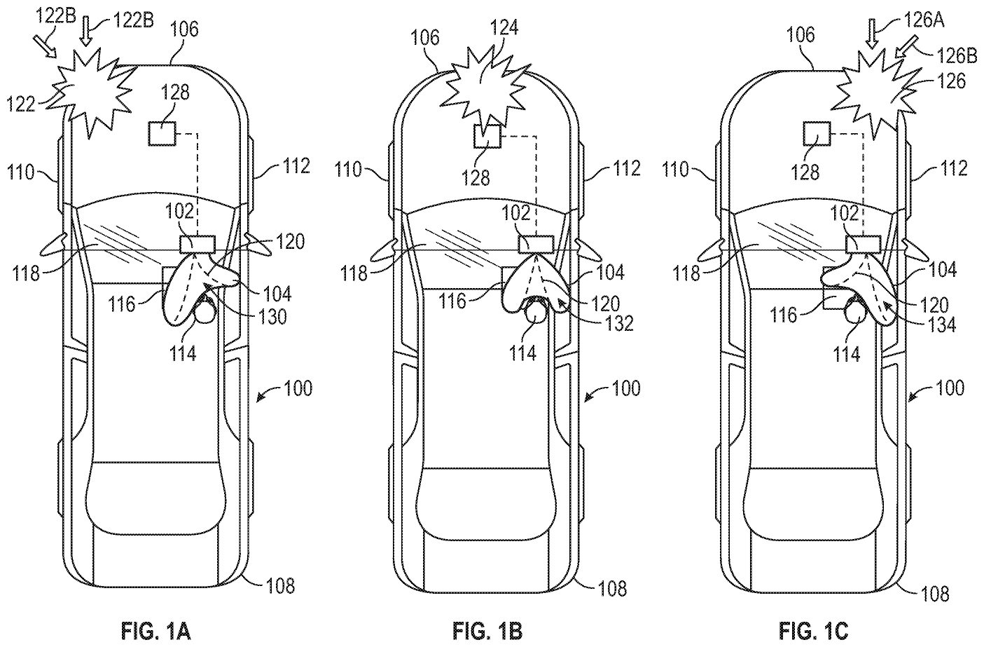

A vehicle 100 having an airbag assembly 102 with an inflatable augmented airbag cushion 104 is diagrammatically shown in FIGS. 1A-1C. The airbag cushion 104 is augmented such that the deployed airbag cushion 104 conforms to a predetermined deployed geometry, or profile, associated with a direction of impact of the vehicle 100. The deployed profile is optimized for the protection of an occupant 114 for a predetermined type of impact, such as a left-offset front impact 122, a center front impact 124, or a right-offset front impact 126. The left-offset front impact 122 includes a left-side front impact 122A and a left-side angle impact 122B. Similarly, the right-offset front impact 126 includes a right-side front impact 126A and a right-side angle impact 126B.

The vehicle 100 may include, but not be limited to, a commercial vehicle, industrial vehicle, passenger vehicle, aircraft, watercraft, train or any mobile platform. The vehicle 100 includes a front end 106, an opposing rear end 108, a left side 110 generally extending between the front end 106 and the rear end 108, and an opposing right side 112 generally extending between the front end 106 and the rear end 108. As understood by those skilled in the art, the front end 106 faces the direction of travel when the vehicle 100 is in a forward motion. Each of the left side 110 and right side 112 of the vehicle 100 coincide with a right-hand and left-hand side of an occupant 114 positioned within the vehicle 100 when the occupant 114 is facing the front end 106 of the vehicle 100.

The vehicle 100 includes a seating structure 116 which supports the occupant 114 in generally opposing relation to an instrument panel 118. The airbag assembly 102 having the inflatable airbag cushion 104 is housed within the instrument panel 118 for outward deployment towards the occupant 114 in the event of a frontal collision. The inflatable airbag cushion 104 is augmented with a tether 120 having a fixed length that may be proportionally adjusted between two portions to provide a deployed airbag profile that is optimized to protect the occupant 114 depending on the type of frontal collision, such as the left-offset front impact 122 as shown in FIG. 1A, the center front impact 124 as shown in FIG. 1B, and the right-offset front impact 126 as shown in FIG. 10. It should be appreciated that the augmented inflatable airbag cushion 104 may be housed within the hub of steering wheel, A-pillar, and/or other forward components of the vehicle 100 without departing from the scope of the invention. It should also be appreciated that the augmented inflatable airbag cushion 104 may be housed in hidden pockets within the seat or door trim panels, and/or in structural components of the vehicle such as the B-pillars, roof, or roof line for the protection of the occupant 114 during a predetermined side impact event.

The vehicle 100 includes an airbag system control module 128 that is configured to detect the direction of impact and forces of impact. If the impact is above a predetermined condition, the airbag control module 128 deploys the airbag cushion 104 and sends a signal to a tether adjustment mechanism 400, an embodiment of which is shown in FIG. 4, to adjust the internal tether 120 such that the deployed profile of the augmented airbag cushion 104 is expanded in the general direction of impact and is contracted in the opposing direction. For the purpose of illustration and disclosure, the profiles of the deployed airbag cushions 104 in FIGS. 1A-1C are shown in an exaggerated depiction.

The first deployed profile 130, as shown in FIG. 1A, is in response to a left-offset front impact 122. The first deployed profile 130 is characterized by a larger volumetric capacity and greater surface area in a left portion of the deployed airbag to protect the occupant 114 in the direction of the left-offset front impact 122. The second deployed profile 132 is shown in FIG. 1B in response to the center front impact 124. The second deployed profile 132 is characterized by an equal distribution of volumetric capacity and surface area to protect the occupant 114. The third deployed profile 134 is shown in FIG. 10 in response to the right-offset impact 126. The third deployed profile 134 is characterized by a larger volumetric capacity and greater surface area in a right portion of the deployed airbag to protect the occupant 114 in the direction of the right-offset front impact 126. Such augmented profile in the direction of impact is achieved through the use of an adjustable tether 120 as illustrated with dash lines in FIGS. 1A-1C. The tether 120 has a fixed overall length, however, the length of the tether 120 may be proportioned between the left and the right portion of the airbag cushion 104 to augment the profile of the deployed airbag cushion 104.

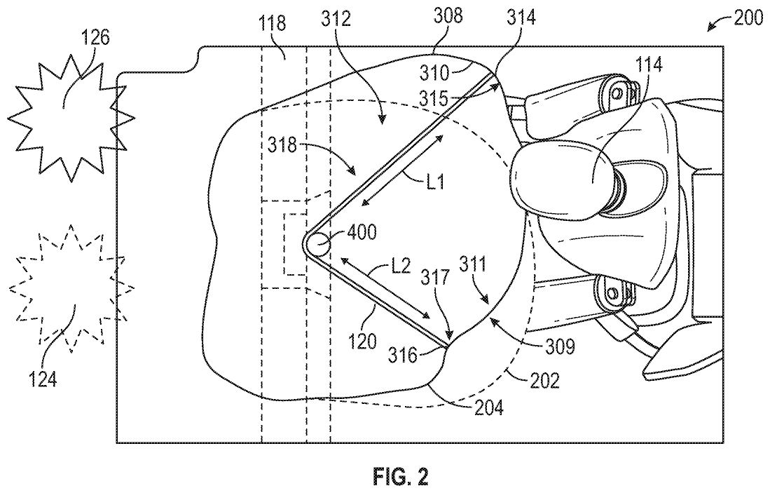

FIG. 2 is a diagrammatic top view of a front occupant 114 seating area 200 with the augmented airbag cushion 104 as deployed in response to a direct front impact 124 and as deployed in response to a right-offset front impact 126. A first deployed profile 202 of the airbag cushion 104 is shown in a dashed-line representing the deployment of the airbag cushion 104 resulting from a center front impact 124. A second deployed profile 204 of the airbag cushion 104 is shown in a solid-line representing the deployment of the airbag cushion 104 resulting from the right-offset front impact 126. The second deployed profile 204 of the airbag cushion 104 is enabled by extending a portion of the length of tether 120 toward the side of impact to allow for the greater deformation of the airbag profile in the general direction of impact, while contracting a same portion of the length of tether 120 from the opposing direction. This proportioning of the length of the tether 120 may be accomplished by the tether adjustment mechanism 400, which is shown in FIG. 4 and disclosed in detail below.

In the current example shown in FIG. 2, upon the vehicle 100 experiencing a right-offset front impact 126, an inflator generates inflator gas directly into the airbag cushion 104. The airbag cushion 104 deploys in an inboard direction towards the front of the occupant 114. During the airbag deployment, the tether 120 is proportionally extended on the right side and contracted on the left side of the occupant 114 by the tether adjustment mechanism 400. The airbag cushion 104 is pulled taut by the tether 120 thereby providing a deployed airbag profile 204 that is characterized by a larger volumetric capacity and greater surface area to protect the occupant 114 in the direction of the right-offset front impact 126.

While the airbag is illustrated for descriptive purposes in relation to a vehicle passenger and to a right-offset front impact 126, it is to be understood that the present disclosure is in no way intended to be limited to a passenger configuration and direction of impact. On the contrary, it is contemplated that the present disclosure may have equal applicability to airbag deployment in opposing relation to the operator 114 of the vehicle 100 from the steering column (not shown) as well as in relation to airbags deployed from other regions within the vehicle interior including, by way of example only, side-impact airbags and inflatable curtain structures.

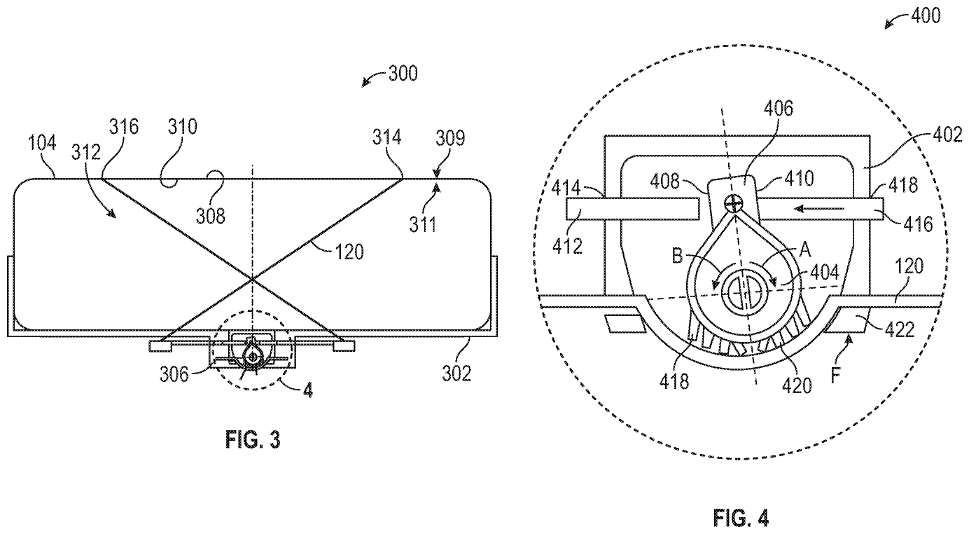

Referring to FIG. 3, a non-deployed airbag assembly 300 is shown. The airbag assembly 300 includes an airbag housing 302, an airbag cushion 104, a tether 120 disposed within the airbag cushion 104, and an inflator 306. The airbag cushion 104 is shown in a folded position and stored in the airbag housing 302 prior to airbag deployment. The tether 120 is shown in a crossed position when the airbag cushion 104 is in the folded position. The inflator 306 may be of any conventional construction which contains chemicals for igniting to generate gas for discharge upon the sensing of predetermined vehicle conditions. The inflator 306 preferably includes ports (not shown) through which the inflator gas is discharged to inflate the airbag cushion 104.

Referring to both FIG. 2 and FIG. 3, the airbag cushion 104 is preferably made of a fabric material which is suitable for airbag cushion construction. The airbag cushion 104 includes an exterior surface 308 defining a lateral external face 309 located adjacent the vehicle occupant 114 during airbag deployment, and interior surface 310 defining a lateral internal face 311 opposite of the lateral external face 309 and interior volume 312. Disposed within the interior volume 312 of the airbag cushion 104 is the interior tether 120. The interior tether 120 is preferably a continuous sheet of flexible, foldable fabric material that is resistant to substantial elongation upon the application of tensile forces. The interior tether 120 includes a first end 314 attached to the airbag cushion 104 preferably proximal to a first portion 315, or right portion 315, of the lateral internal face 311. The interior tether 120 also includes a second end 316 attached to a second portion 317, or left portion 317, of the lateral internal face 311. The first portion 315 and the second portion 317 of the lateral internal face 311 is laterally spaced apart proximal to the right hand-side and left hand-side, respectively, of the occupant 114 when the airbag cushion 104 is deployed.

The first and second ends 314, 316 of the internal tether 120 may be attached, or joined, to the first and second portions 315, 317 of the lateral internal face 311, respectively, by any suitable joining technique as may be known to those of skill in the art including, by way of example only, the application of a sewn seam as may be applied using industrial sewing equipment. Other modes of attachment may include adhesive bonding, ultrasonic welding, RF welding, and combinations thereof. Alternatively, the first and second ends 314, 316 of the internal tether 120 may be integrally woven into the first and second portions 315, 317, respectively, of the lateral internal face 311. The tether 120 also includes a fixed length middle segment 318 extending between the first end 314 and the second end 316. The middle segment 318 extends through the tether adjustment mechanism 400. A first tether length L1 is defined between the tether adjustment mechanism 400 and the first end 314, and a second tether length L2 is defined between the tether adjustment mechanism 400 and the second end 316.

FIG. 4 shows a tether adjustment mechanism 400 configured to selectively increase one of the first tether length L1 and the second tether length L2 by a predetermined length, while decreasing the other of the first tether length L1 and the second tether length L2 by the same predetermined length. The tether adjustment mechanism 400 includes a housing 402 and a cam member 404 pivotally disposed within the housing 402. The cam member 404 includes a lever 406 having a first surface 408 and an opposing second surface 410. A slidable first plunger 412 is inserted through a first opening 414 in the housing 402 and is selectively engageable with the first surface 408 to induce a rotation of the cam member 404 in a first pivotal direction A. A slidable second plunger 416 is inserted through a second opening 418 in the housing 402 and may selectively engage the second surface 410 to induce a rotation of the cam member 404 in a second pivotal direction B. The first and second plungers 412, 414 may be activated to engage the first and second surfaces 408, 410, respectively, by any electro-mechanical means such as an electric motor, preloaded springs (not shown), pyrotechnic means (not shown), or by the inflator 306.

The cam member 404 includes a plurality of pawl teeth 420 in frictional engagement with the tether 120 such that the pawl teeth 420 induces the tether 120 to move in the direction of pivot of the cam member 404. For example, when the airbag control module 128 detects an offset impact on the left side of vehicle 100, the second plunger 416 is activated to engage the second side 410 of the lever 406 causing the cam member 404 to rotate in the second pivotal direction B. In this example, as the cam member 404 rotates in the second pivotal direction B, the pawl teeth 420 induces a movement of the tether 120, thus increasing the volume of the airbag on the left side of the vehicle 100. Although the embodiment shows a single internal tether 120, it should be appreciated that more than one tether 120 could also be used.

The tether adjustment mechanism 400 may also include a locking tab 422 that may be activated by electro-mechanical means (not shown) or by the igniter. The locking tab 422 is configured to pin a portion of the tether 120 against the housing 402 such that the tether 120 is immobilized. This would assist in maintaining the desired profile of the inflatable airbag cushion 104 during deployment of the airbag cushion 104.

It is contemplated that the use of the variable profile airbag according to the present invention will permit a single cushion to be utilized to effectively protect an occupant 114 for a wide range of potential impact scenarios that is not typical of a straight head-on collision or side collision. The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An augmented airbag assembly for a vehicle, comprising:
an inflator for generating a gas;
an airbag cushion deployable upon generation of the gas by the inflator;
a tether having a first end connected to a first portion of the airbag cushion, a second end connected to a second portion of the airbag cushion, and a middle segment extending between the first end and the second end; and
a tether adjustment mechanism engaged to a portion of the middle segment of the tether, thereby defining a first tether length between the tether adjustment mechanism and the first end, and a second tether length between the tether adjustment mechanism and the second end;
wherein the tether adjustment mechanism is configured to ratchet the portion of the middle segment of the tether when the airbag cushion deploys such that one of the first tether length and the second tether length is extended, and the other of the first tether length and the second tether length is contracted.

2. The augmented airbag assembly of claim 1, wherein the middle segment includes a fixed tether length.

3. The augmented airbag assembly of claim 2, wherein the one of first tether length and second tether length is extended to a predetermined length, and the other of the first tether length and the second tether length is contracted the same predetermined length.

4. The augmented airbag assembly of claim 1, wherein the first portion of the airbag cushion is a right lateral portion of the airbag cushion when the airbag cushion is deployed and the second portion of the airbag cushion is a left lateral portion of the airbag cushion when the airbag cushion is deployed.

5. The augmented airbag assembly of claim 4, wherein:
the airbag cushion includes an exterior surface defining a lateral external face, and an interior surface defining a lateral internal face opposite of the lateral external face and an interior volume, wherein the lateral internal face includes the right lateral portion and the left lateral portion;
the tether is disposed within the interior volume of the airbag cushion; and
the first end and second end of the tether is connected to the right lateral portion and to the left lateral portion of the lateral internal face.

6. The augmented airbag assembly of claim 1, wherein the tether adjustment mechanism comprises:
a housing;
a cam member pivotally disposed within the housing, the cam member including a lever having a first surface and an opposing second surface;
a first plunger selectively engageable with the first surface to induce a rotation of the cam member in a first pivotal direction, thereby causing the first tether length to extend in the first direction; and
a second plunger selectively engageable with the second surface to induce a rotation of the cam member in a second pivotal direction, thereby causing the second tether length to extend in the first direction.

7. The augmented airbag assembly of claim 6, wherein the cam member further includes a plurality of pawl teeth engaging the portion of the middle segment of the tether.

8. The augmented air bag assembly of claim 7, wherein the tether adjustment mechanism includes a tether locking tab configured to pin the portion of the middle segment against the housing such that the tether is immobilized.

9. The augmented air bag assembly of claim 8, wherein the first and second plungers are slidable through a first and second openings, respectively, defined in the housing.

10. The augmented airbag assembly of claim 1, wherein the tether comprises a continuous sheet of flexible foldable fabric material that is resistant to substantial elongation upon an application of tensile forces during deployment of the airbag cushion.

11. An airbag system for a vehicle comprising:
an airbag control module configured to detect a direction of impact of the vehicle and to deploy an airbag assembly upon a predetermined condition of impact;
the airbag assembly comprising:
an airbag cushion having an exterior surface defining a lateral external face, and interior surface defining a lateral internal face opposite of the lateral external face and interior volume;
a tether disposed within the interior volume of the airbag cushion, wherein the tether includes a first end and a second end, and wherein the first end and the second end of the tether is connected to a right portion and to a left portion of the lateral internal face, respectively; and
a tether adjustment mechanism in communication with the airbag control module and in engagement with the tether;
wherein the airbag control module is configured to send a signal to the tether adjustment mechanism to adjust the tether such that a deployed profile of the airbag cushion is expanded generally in the direction of impact.

12. An airbag system of claim 11, wherein:
the tether further includes a middle segment extending between the first end and the second end; and
the tether adjustment mechanism is engaged to a portion of the middle segment of the tether, thereby defining a first tether length between the tether adjustment mechanism and the first end, and a second tether length between the tether adjustment mechanism and the second end.

13. The airbag system of claim 12, wherein tether adjustment mechanism is configured to ratchet the portion of the middle segment of the tether when the airbag cushion deploys such that one of the first tether length and the second tether length is extended and the other of the first tether length and the second tether length is contracted to provide a larger volumetric capacity of the airbag cushion in the direction of impact.

14. The airbag system of claim 13, wherein the tether adjustment mechanism includes:
a cam member including a lever having a first surface and an opposing second surface;
a first plunger selectively engageable with the first surface to induce a rotation of the cam member in a first pivotal direction, thereby causing the first tether length to be extended; and
a second plunger selectively engageable with the second surface to induce a rotation of the cam member in a second pivotal direction, thereby causing the second tether length to be extended.

15. The airbag system of claim 14, wherein the cam member further includes a plurality of pawl teeth engaging the portion of the middle segment of the tether.

16. An augmented airbag assembly having a reconfigurable deploy geometry, comprising:
a tether having a first end, an opposite second end, and a middle segment extending between the first end and the second end;
a tether adjustment mechanism engaged to a portion of the middle segment of the tether, thereby defining a first tether length between the tether adjustment mechanism and the first end, and a second tether length between the tether adjustment mechanism and the second end.

17. The augmented airbag assembly of claim 16, further comprising:
an airbag cushion having an exterior surface defining a lateral external face, and interior surface defining a lateral internal face opposite of the lateral external face and interior volume;
wherein the tether is disposed within the interior volume of the airbag cushion, wherein the first end and second end of the tether is connected to a right portion and to a left portion of the lateral internal face, respectively.

18. The augmented airbag assembly of claim 17, further comprising:
an airbag control module configured to detect a direction of impact of a vehicle and to deploy an airbag assembly upon certain conditions of impact, wherein the airbag control module is in communication with the tether adjustment mechanism.

19. The augmented airbag assembly of claim 18, wherein the airbag control module sends a signal to the tether adjustment mechanism to ratchet the portion of the middle segment of the tether when the airbag cushion deploys such that one of first tether length and second tether length is extended, and the other of the first tether length and the second tether length is contracted.

20. The augmented airbag assembly of claim 19, wherein one of the first tether length and the second tether length is extended to a predetermined length, and the other of the first tether length and the second tether length is contracted to the same predetermined length.
